(19) United States
(12) Patent Application Publication
(10) Pub. No.: US 2015/0212372 A1
(43) Pub. Date: Jul. 30, 2015

(54) LIQUID CRYSTAL PIXEL ELECTRODE STRUCTURE, ARRAY SUBSTRATE AND DISPLAY APPARATUS

(71) Applicants: HEFEI BOE OPTOELECTRONICS TECHNOLOGY CO. , LTD., Hefei, Anhui (CN); BOE TECHNOLOGY GROUP CO., LTD., Beijing (CN)

(72) Inventors: Jongwon Moon, Beijing (CN); Qiang Huang, Beijing (CN); Taekyu Park, Beijing (CN)

(73) Assignee: HEFEI BOE OPTOELECTRONICS TECHNOLOGY CO., LTD., Hefei, Anhui (CN)

(21) Appl. No.: 14/352,190

(22) PCT Filed: Jun. 17, 2013
(86) PCT No.: PCT/CN2013/077343

§ 371 Date: Apr. 16, 2014

(30) Foreign Application Priority Data
Apr. 7, 2013 (CN) 201310118866.8

(51) Int. Cl. G02F 1/1337; G02F 1/1343

(52) U.S. Cl. CPC G02F 1/133707; G02F 1/13439; G02F 1/134309

(57) ABSTRACT

A liquid crystal pixel electrode structure, an array substrate, and a display apparatus are provided. The pixel electrode structure comprises a first pixel electrode (7), a second pixel electrode (8) and a common electrode (9), wherein the first pixel electrode (7) and the second pixel electrode (8) are arranged in turn with an interval and are located above the common electrode (9), and the first pixel electrode (7) and the second pixel electrode (8) have different driving voltages and form equal absolute value of voltage difference with the common electrode (9), respectively. An electric field may be generated between the two kinds of pixel electrodes, and meantime, the two kinds of pixel electrodes may also generate an electric field with the common electrode (9), and the two kinds of electric fields together can reduce the demand for the driving voltage and power consumption. In addition, the common electrode may use a slit electrode, so that the light transmittance is improved.

### BACKGROUND

Embodiments of the present invention relate to a liquid crystal pixel electrode structure, an array substrate, and a display apparatus.

In liquid crystal display technology, ADvanced Super Dimension Switch (AD-SDS, or ADS) mode is gradually replacing the Twisted Nematic (TN) liquid crystal mode due to its high light transmittance, wide viewing angle, fast response speed and low power consumption, and becomes one of the important technologies in the liquid crystal display field.

Liquid crystal display based on the ADS mode forms a multi-dimensional electrical field by an electric field generated by edges of the slit electrodes in the same plane and an electric field generated by a slit electrode layer and a plate-shape electrode layer, to rotate all the oriented liquid crystal molecules located between the slit electrodes and direct above the electrodes in the LC cell, so as to improve the operation efficiency of the liquid crystal and increase the light transmittance efficiency. The ADS technology can improve picture quality of TFT-LCD product, and has advantages, such as high resolution, high transmittance, low power consumption, wide viewing angle, high aperture ratio, low color aberration, no push Mura, and so on.

The structure of a display panel in the conventional ADS mode is shown in FIG. 1, and comprises a color filter substrate 2, an array substrate 3, and liquid crystal 1 injected between the two substrates after the two substrates are bonded, wherein the array substrate 3 further comprises a pixel electrode 4 (correspond to a slit electrode), a common electrode 5 and a passivation layer 6. The left of the dash line in FIG. 1 represents the state (off) in which the voltage is not applied, and the right represents the state (on) in which the voltage is applied. When the voltage is applied, the electrical field lines in the cell is of a parabola shape, and the liquid crystal molecules are twisted and rotated under the act of the electrical field lines, so as to achieve the goal of controlling the light. The light transmittance characteristic of the liquid crystal pixel electrode structure in the conventional ADS mode is as shown by the curve in FIG. 2, wherein the light transmittance is the highest at the edges of the pixel electrode, and the light transmittance is the minimum at the point of the middle of adjacent pixel electrodes and the point of the middle of the pixel electrode.

In a conventional ADS mode, it uses a design in which one single pixel electrode completely covers the common electrode, and the electrode is generally a layer of ITO thin film. The light transmittance of ITO is about 91%, so the transmittance of the light passed the two layers of ITO thin film (the pixel electrode and the common electrode) is about 80%, and the loss is about 20%. In addition, the electric field at the point between adjacent pixel electrodes and at the middle point of the pixel electrode in the conventional ADS mode is weaker, and it requires a higher driving voltage to drive the liquid crystal.

### SUMMARY

Embodiments of the present invention provide a liquid crystal pixel electrode structure, an array substrate, and a display apparatus, which can solve one or more of the technical problems in the prior art, for example, reduce driving voltage, reduce power consumption, and improve light transmittance of the conventional ADS mode.

According to an aspect of the present invention, a liquid crystal pixel electrode structure is provided, comprising a first pixel electrode, a second pixel electrode and a common electrode, wherein the first pixel electrode and the second pixel electrode are arranged in turn with an interval therebetween, and are above the common electrode, and the first pixel electrode and the second pixel electrode have different driving voltages and form equal absolute value of voltage difference with the common electrode, respectively.

In an embodiment, the common electrode may be a slit electrode.

In an embodiment, the slit electrode has an opening in a position which may correspond to a location of the first pixel electrode or the second pixel electrode.

In an embodiment, the opening has an area which may be smaller than that of the corresponding first pixel electrode or second pixel electrode.

In an embodiment, the first pixel electrode and the second pixel electrode may be made of ITO material.

In an embodiment, the common electrode may be made of ITO material.

In an embodiment, the liquid crystal pixel electrode structure may further comprise a passivation layer between the common electrode and the first and second pixel electrodes.

An embodiment of the present invention further provides an array substrate, comprising the described liquid crystal pixel electrode structure.

An embodiment of the present invention further provides a display apparatus, comprising the described array substrate.

In the embodiments of the present invention, an electric field can be generated between the two kinds of pixel electrodes, and meantime, the two kinds of pixel electrodes and the common electrode can also generate an electric field, and the two kinds of electric fields together can reduce the demand for driving voltage and reduce power consumption. In addition, in the embodiments of the present invention, the common electrode can use a slit electrode, so that the light transmittance is improved.

### BRIEF DESCRIPTION OF DRAWINGS

FIG. 1 is a structural view of a display panel of a conventional ADS mode;

FIG. 2 is a characteristic chart of the light transmittance of a liquid crystal pixel electrode structure in a conventional ADS mode;

FIG. 3 is a schematic view of a liquid crystal pixel electrode structure in one ADS mode provided by an embodiment of the present invention;

FIG. 4 is a schematic view of driving voltage required to be provided in an embodiment of the present invention; and

FIG. 5 is a characteristic chart of the light transmittance of a liquid crystal pixel electrode structure in a ADS mode provided by an embodiment of the present invention.

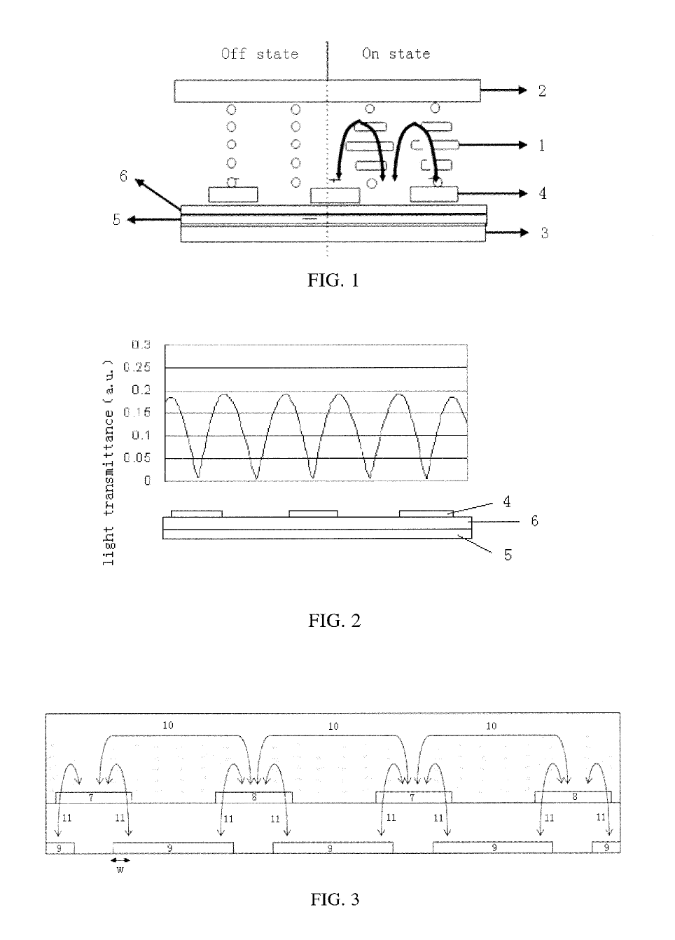

### DETAILED DESCRIPTION

The detailed implementations of the present invention will be further described in detail below in conjunction with the accompanying drawings and embodiments. The following embodiments are used to explain the present invention, and not intended to limit the scope of the present invention.

FIG. 3 is a schematic view of a liquid crystal pixel electrode structure in one ADS mode provided by an embodiment of the present invention, and the liquid crystal pixel electrode structure comprises: a first pixel electrode 7, a second pixel electrode 8 and a common electrode 9, wherein the first pixel electrode 7 and the second pixel electrode 8 are arranged in turn with an interval therebetween, and are located above the common electrode 9.

The first pixel electrode 7 and the second pixel electrode 8 may have different driving voltages, and an electric field may be generated therebetween. The electric field lines are indicated by numeral 10. Meantime, the first pixel electrode 7 and the second pixel electrode 8 may also generate an electric field with the common electrode 9, respectively, and the electric field lines are indicated by numeral 11.

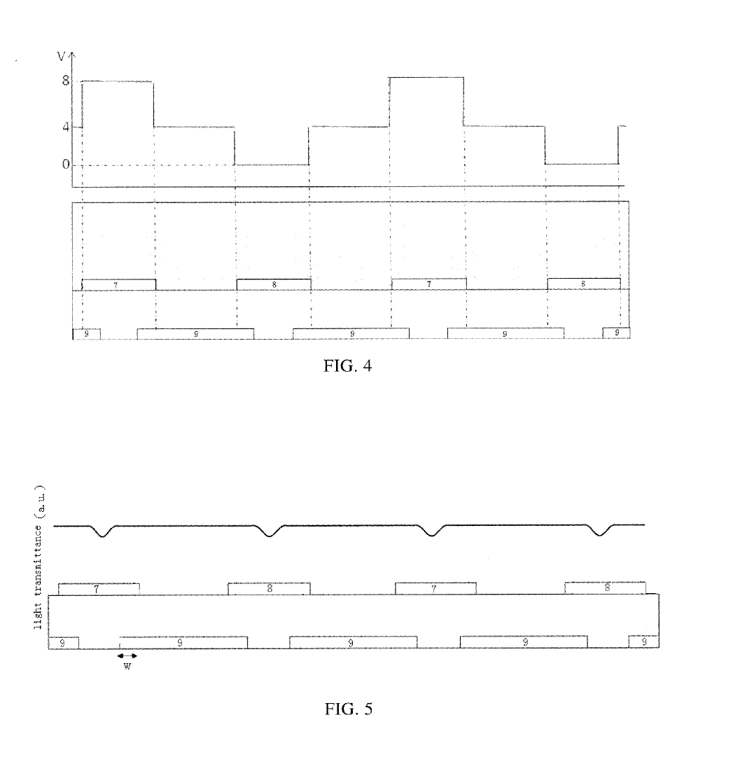

In an embodiment of the present invention, the first pixel electrode 7 and the second pixel electrode 8 may form equal voltage difference with the common electrode 9 respectively. For example, the driving voltages provided to the first pixel electrode 7 and the second pixel electrode 8 may be 8V and 0V respectively, and the driving voltage provided to the common electrode 9 may be 4V, then the voltage difference between the first pixel electrode 7 and the second pixel electrode 8 is 8V, and the absolute values of the voltage difference between the two kinds of pixel electrodes and the common electrode 9 are both 4V. FIG. 4 is a schematic view of the driving voltage required to be provided in an embodiment of the present invention. The value of the driving voltage shown in FIG. 4 is only an example, and the present invention is not limited thereto.

Since the electric field at the position between adjacent pixel electrodes and at the middle position of the pixel electrode is weaker in the conventional ADS mode, it requires a higher driving voltage to drive the liquid crystal. However, the embodiments of the present invention use the electric field between the first pixel electrode 7 and the second pixel electrode 8, and by the combination function of the two electric fields (10 and 11), it reduces the demand for the driving voltage and reduces power consumption.

The first pixel electrode 7 and the second pixel electrode 8 may be made of ITO material, and the common electrode 9 may also be made of ITO material. The liquid crystal pixel electrode structure may further comprise a passivation layer between the common electrode 9 and the first and second pixel electrodes 7 and 8.

In an embodiment of the present invention, the common electrode 9 may be a slit electrode, and the position of the opening of the slit electrode may correspond to the position of the first pixel electrode 7 or the second pixel electrode 8. Alternatively, the area of the opening may be smaller than the area of the corresponding first pixel electrode 7 or second pixel electrode 8.

Since the common electrode has been etched away by a portion region, the light does not have to transmit two layers of ITO electrode, so that the light transmittance is improved. Meantime, since the area of the common electrode is reduced, it can reduce the storage capacitance and the electric power consumption, and further reduce power consumption. The storage capacitance may be determined by an equation

$$C = ɛ \frac{S}{d} ,$$

wherein ε is the dielectric constant, S is the overlapping area of the common electrode and the corresponding pixel electrode, and d is the distance between the common electrode and the pixel electrodes.

A characteristic chart of the light transmittance of the liquid crystal pixel electrode structure in the ADS mode provided by the embodiment of the present invention is shown in FIG. 5. As shown in FIG. 5, compared with the conventional technology, the light transmittance at the place between adjacent pixel electrodes and at the middle position of the pixel electrode is improved.

An embodiment of the present invention further provides an array substrate, and the array substrate comprises the described liquid crystal pixel electrode structure.

An embodiment of the present invention further provides a display apparatus, and the display apparatus comprises the described array substrate.

The forgoing are only preferable implementations of the present invention, and it is to be noted that, an ordinary person in the art may further make various modifications and replacements, without departing the technical principle of the present invention, and these modifications and replacements should be deemed within the protection scope of the present invention.

1. A liquid crystal pixel electrode structure, comprising:
a first pixel electrode;
a second pixel electrode; and
a common electrode;
wherein the first pixel electrode and the second pixel electrode are arranged in turn with an interval therebetween and are above the common electrode, and the first pixel electrode and the second pixel electrode have different driving voltages and form equal absolute value of voltage difference with the common electrode, respectively.

2. The liquid crystal pixel electrode structure according to claim 1, wherein the common electrode is a slit electrode.

3. The liquid crystal pixel electrode structure according to claim 2, wherein the slit electrode has an opening in a position corresponding to a location of the first pixel electrode or the second pixel electrode.

4. The liquid crystal pixel electrode structure according to claim 3, wherein the opening has an area smaller than that of the corresponding first pixel electrode or second pixel electrode.

5. The liquid crystal pixel electrode structure according to claim 1, wherein the first pixel electrode and the second pixel electrode are made of ITO material.

6. The liquid crystal pixel electrode structure according to claim 1, wherein the common electrode is made of ITO material.

7. The liquid crystal pixel electrode structure according to claim 1, further comprising a passivation layer between the common electrode and the first pixel electrode and the second pixel electrode.

8. An array substrate, comprising the liquid crystal pixel electrode structure according to claim 1.

9. A display apparatus, comprising the array substrate according to claim 8.

10. The liquid crystal pixel electrode structure according to claim 2, wherein the first pixel electrode and the second pixel electrode are made of ITO material.

11. The liquid crystal pixel electrode structure according to claim 3, wherein the first pixel electrode and the second pixel electrode are made of ITO material.

12. The liquid crystal pixel electrode structure according to claim 4, wherein the first pixel electrode and the second pixel electrode are made of ITO material.

13. The liquid crystal pixel electrode structure according to claim 12, wherein the common electrode is made of ITO material.

14. The liquid crystal pixel electrode structure according to claim 13, further comprising a passivation layer between the common electrode and the first pixel electrode and the second pixel electrode.

15. The liquid crystal pixel electrode structure according to claim 2, wherein the common electrode is made of ITO material.

16. The liquid crystal pixel electrode structure according to claim 3, wherein the common electrode is made of ITO material.

17. The liquid crystal pixel electrode structure according to claim 4, wherein the common electrode is made of ITO material.

18. The liquid crystal pixel electrode structure according to claim 2, further comprising a passivation layer between the common electrode and the first pixel electrode and the second pixel electrode.

19. The liquid crystal pixel electrode structure according to claim 3, further comprising a passivation layer between the common electrode and the first pixel electrode and the second pixel electrode.

20. The liquid crystal pixel electrode structure according to claim 4, further comprising a passivation layer between the common electrode and the first pixel electrode and the second pixel electrode.
